(19) United States
(12) Patent Application Publication
(10) Pub. No.: US 2013/0285270 A1
(43) Pub. Date: Oct. 31, 2013

(54) TRANSFER APPARATUS AND METHOD OF MANUFACTURING ARTICLE

(71) Applicant: CANON KABUSHIKI KAISHA, Tokyo (JP)

(72) Inventors: Kenji Yaegashi, Utsunomiya-shi (JP); Yukio Takabayashi, Saitama-shi (JP)

(73) Assignee: CANON KABUSHIKI KAISHA, Tokyo (JP)

(21) Appl. No.: 13/833,073

(22) Filed: Mar. 15, 2013

(30) Foreign Application Priority Data
Apr. 25, 2012 (JP) 2012-100348

(51) Int. Cl. B29C 59/02

(52) U.S. Cl. CPC B29C 59/02
USPC 264/40.5; 425/150

(57) ABSTRACT

A transfer apparatus transfers a pattern of an original to a resin on a shot region of a substrate. The original includes a first surface and second surface which are surfaces opposite to each other. The first surface includes a pattern region where the pattern is formed, and the second surface includes a holding surface. The apparatus includes a plurality of holding units configured to hold the holding surface of the original, a plurality of driving units configured to drive the plurality of holding units, respectively, and a control unit configured to control driving of the plurality of holding units by the plurality of driving units to align the pattern region with the shot region of the substrate.

### BACKGROUND OF THE INVENTION

1. Field of the Invention

The present invention relates to a transfer apparatus which transfers the pattern of an original to a substrate, and a method of manufacturing an article.

2. Description of the Related Art

With recent advances in micropatterning of semiconductor devices, an imprint technique of coating a substrate with a resin and curing the resin while an original (mold) is in contact with the resin has received attention as a semiconductor device manufacturing method. In the imprint technique, it is important to reduce the alignment error between a pattern on a substrate and the pattern of an original, similar to photolithography using an exposure apparatus. In association with this, Japanese Patent Laid-Open Nos. 2007-535121 and 2008-504141 disclose techniques for applying a force to the side face of an original to deform the original.

A mechanism which deforms an original, and its problem will be explained with reference to FIG. 8. The imprint apparatus includes a substrate stage 106 which holds a substrate 105, an imprint head 101, a measurement device 107, and a coating head 108 which coats the substrate 105 with a resin. The imprint head 101 includes a chuck 102 which holds an original 104, and a pair of actuators 103 which apply a compression force to opposite side faces of the original 104. After the coating head 108 coats the substrate 105 with a resin, the original 104 and substrate 105 are aligned. This alignment is performed by measuring the relative position between a mark 109 on the original 104 and a mark 110 on the substrate 105 by using the measurement device 107, and applying a compression force to the side faces of the original 104 by the pair of actuators 103 based on the measurement result.

In this arrangement, the compression force is applied to the side faces of the original 104 while the original 104 is held by the chuck 102, so an excessive stress may be applied to the original 104. In this arrangement, the original 104 can be deformed only in a direction in which its dimensions are reduced. Further, the distance between the pattern portion of the original 104 and the side face of the original 104 to which a compression force is applied is long, and the controllability and efficiency of deformation are poor.

### SUMMARY OF THE INVENTION

The present invention provides a technique advantageous for alignment between an original and a shot region on a substrate.

One of the aspects of the present invention provides a transfer apparatus which transfers a pattern of an original to a resin on a shot region of a substrate, the original including a first surface and second surface which are surfaces opposite to each other, the first surface including a pattern region where the pattern is formed, and the second surface including a holding surface, the transfer apparatus comprising: a plurality of holding units configured to hold the holding surface of the original; a plurality of driving units configured to drive the plurality of holding units, respectively; and a control unit configured to control driving of the plurality of holding units by the plurality of driving units to align the pattern region with the shot region of the substrate.

Further features of the present invention will become apparent from the following description of exemplary embodiments with reference to the attached drawings.

### BRIEF DESCRIPTION OF THE DRAWINGS

FIGS. 1A and 1B are views schematically showing the arrangement of a transfer apparatus according to one embodiment of the present invention;

FIG. 2 is a sectional view schematically exemplifying the structure of an original used in the transfer apparatus configured as an imprint apparatus;

FIGS. 3A to 3D are views for explaining a positional shift measurement principle using a moire pattern;

FIGS. 4A to 4C are views exemplifying an imprint head;

FIGS. 5A and 5B are views for explaining the first example of a method of aligning an original with respect to the shot region of a substrate;

FIGS. 6A and 6B are views for explaining the second example of the method of aligning an original with respect to the shot region of a substrate;

FIGS. 7A to 7C are views for explaining the third example of the method of aligning an original with respect to the shot region of a substrate; and

FIG. 8 is a view for explaining a mechanism which deforms an original, and its problem.

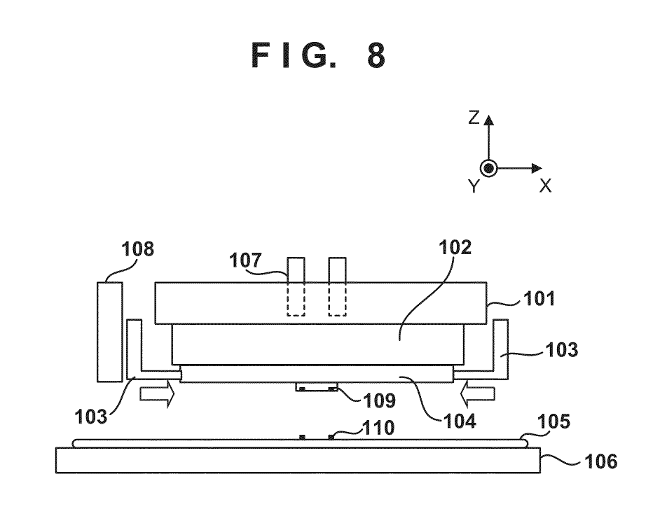

### DESCRIPTION OF THE EMBODIMENTS

A preferred embodiment of the present invention will now be described with reference to the accompanying drawings.

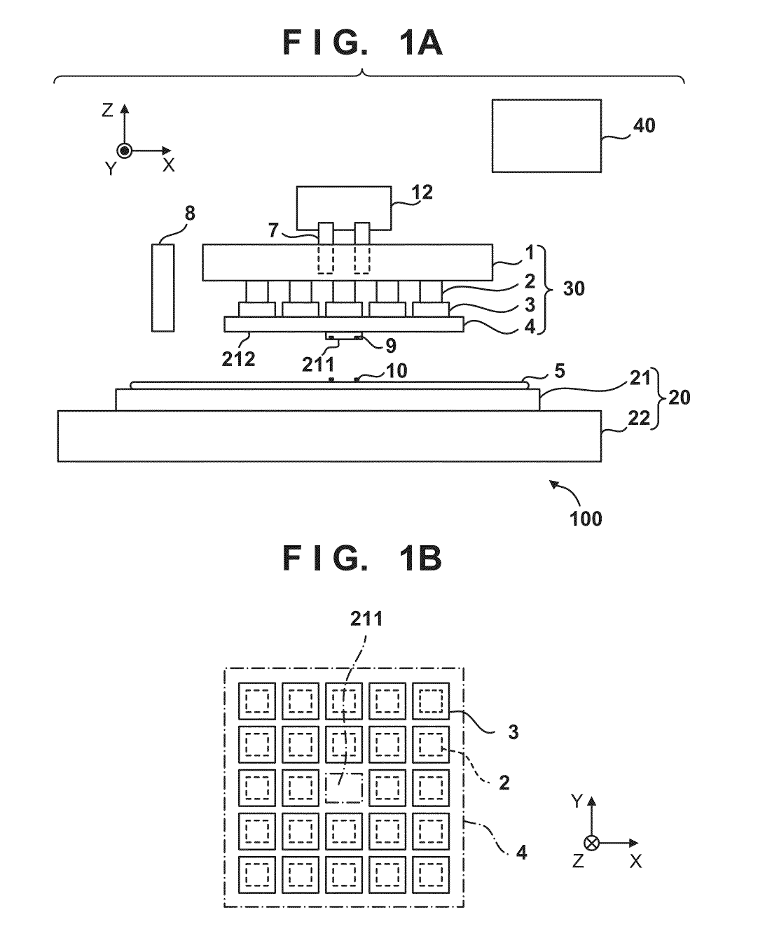

FIGS. 1A and 1B schematically show the arrangement of a transfer apparatus 100 according to one embodiment of the present invention. The transfer apparatus 100 is configured to transfer the pattern of an original 4 to a resin on a substrate 5. The transfer apparatus 100 can be configured typically as an imprint apparatus which brings the pattern region of the original 4 into contact with a resin on a shot region on the substrate 5, and cures the resin by energy applied to the resin from a curing unit 12 in this state. The curing unit 12 can be configured to, for example, cure a resin by irradiating the resin with light such as ultraviolet light. Alternatively, the curing unit 12 may be configured to cure a resin by applying heat to the resin. Although not shown in FIGS. 1A and 1B, the transfer apparatus 100 may use a reflection original 4, and project the pattern of the original 4 to a photosensitive resin on the substrate 5 via an optical system to expose the resin to light, thereby transferring the pattern of the original 4 to the resin.

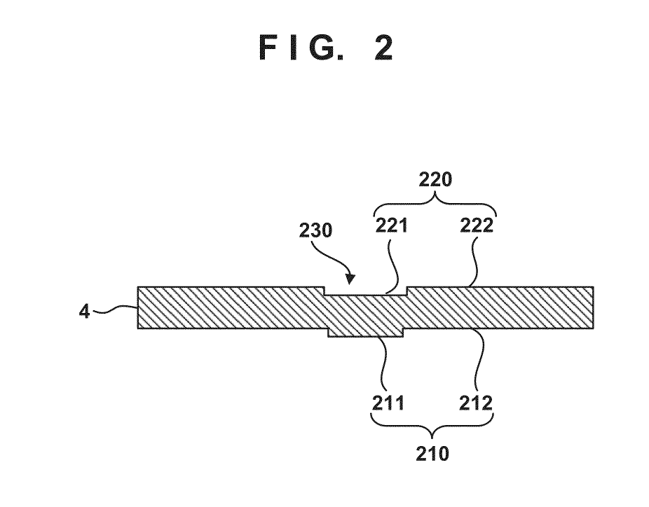

An example in which the transfer apparatus 100 is configured as an imprint apparatus will be explained. FIG. 2 is a sectional view schematically exemplifying the structure of the original 4 used in the transfer apparatus 100 configured as the imprint apparatus. The original 4 has a first surface 210 and second surface 220 which are surfaces opposite to each other. The first surface 210 can include a pattern region 211 where a pattern is formed, and the second surface 220 can include a holding surface 222. In addition to the pattern region 211, the first surface 210 can have a peripheral region 212 surrounding the pattern region 211. In addition to the holding surface 222, the second surface 220 can have a portion 221 surrounded by the holding surface 222. The portion 221 can be positioned on a side opposite to the pattern region 211. The portion 221 can be recessed from the holding surface 222 and form a space 230.

The transfer apparatus 100 can include a positioning mechanism 20 which positions the substrate 5, an imprint head 30, a measurement device 7, a coating head 8 which coats the substrate 5 with a resin, a curing unit 12 which cures a resin on the substrate 5, and a control unit 40. The positioning mechanism 20 can include a stage 21 which holds the substrate 5, and a driving mechanism 22 which drives and positions the stage 21. The imprint head 30 can include a plurality of holding units (chucks) 3 which hold the original 4, a plurality of driving units 2 which drive the holding units 3, respectively, and an elevating mechanism 1 which elevates the driving units 2. Each holding unit 3 has a chucking surface for chucking (for example, vacuum-chucking) the holding surface 222 of the original 104. When the elevating mechanism 1 moves down the driving units 2, the original 4 moves down, and the pattern region 211 of the original 4 comes into contact with the resin on the shot region of the substrate 5. When the elevating mechanism 1 moves up the driving units 2, the original 4 moves up, and the pattern region 211 of the original 4 is released from the resin on the shot region of the substrate 5.

After the coating head 8 coats the substrate 5 with a resin, the original 4 and the shot region of the substrate 5 are aligned. This alignment is performed as follows. First, the relative position between a mark 9 on the original 4 and a mark 10 on the substrate 5 is measured using the measurement device 7. Then, the control unit 40 controls driving of the holding units 3 by the driving units 2 based on the measurement result to reduce the relative position.

The measurement device 7 measures the relative position between the marks 9 and 10 based on a moire pattern formed when the mark (original-side mark) 9 formed on the original 4 comes close to the mark (substrate-side mark) 10 formed in the shot region on the substrate 5. For example, when a highly volatile resin is used, the coating head 8 can be configured to coat the substrate 5 with the resin for each shot region or a plurality of shot regions. When a poorly volatile resin is used, it is also possible to coat the entire surface of the substrate 5 with the resin and then transfer the pattern of the original 4 to each shot region.

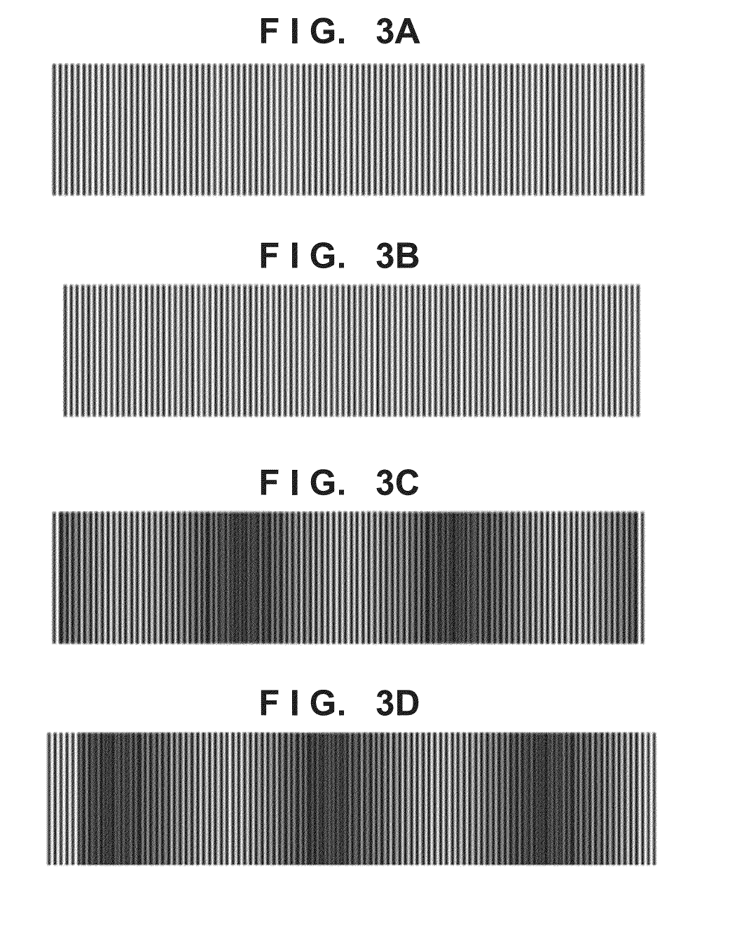

A method of measuring the relative position between the marks 9 and 10 by using a moire pattern will be explained with reference to FIGS. 3A to 3D. Two types of grating marks having different pitches exemplified in FIGS. 3A and 3B are formed as the marks 9 and 10 on the original 4 and substrate 5. When these grating marks are superimposed, a pattern of bright and dark fringes appears, as exemplified in FIG. 3C. This fringe pattern is the moire pattern. In the moire pattern, bright and dark positions change depending on a change of the relative position between the two types of grating marks. For example, when one of the two types of grating marks is shifted slightly rightward, the moire pattern exemplified in FIG. 3C changes to one in FIG. 3D. This moire pattern is generated as thick bright and dark fringes in which the actual shift amount between the two types of grating marks is increased. Therefore, even if the resolution of the measurement device 7 is low, the relative position between the two types of grating marks can be measured at high precision. By using this, the relative position between the original 4 and the shot region of the substrate 5 can be measured.

The method of measuring the relative position between the original 4 and the substrate 5 is not limited to the method using the moire pattern, and various other methods are available. For example, the mark 9 formed on the original 4 and the mark 10 formed on the substrate 5 may be simultaneously observed via an imaging optical system, and the relative position between them may be measured. The measurement device 7 can have, for example, a function of measuring the distance (distance in the Z direction) between the original 4 and the substrate 5. The distance between the original 4 and the substrate 5 can be measured by, for example, focusing on the marks 9 and 10. Note that the X, Y, and Z directions are defined in the transfer apparatus 100. In the transfer apparatus 100, a direction in which the original 4 is driven to bring the pattern region 211 of the original 4 into contact with the resin on the substrate 5 is the Z direction, and directions perpendicular to the Z direction are the X and Y directions.

The alignment between the original 4 and the substrate 5 in the imprint apparatus is preferably die-by-die alignment. This is because the imprint apparatus performs contact and release between the resin on the substrate 5 and the original 4, and the positions of the original 4 and substrate 5 may change at this time. The measurement device 7 measures the relative position between the original 4 and the shot region of the substrate 5 while the pattern region 211 of the original 4 is in contact with the resin on the substrate 5. Based on information obtained by this measurement, the control unit 40 controls driving of the holding units 3 by the driving units 2 to reduce the alignment error between an underlying pattern formed on the substrate 5 and the pattern of the original 4. The curing unit 12 applies energy to the resin to cure the resin. After that, the original 4 is released from the cured resin.

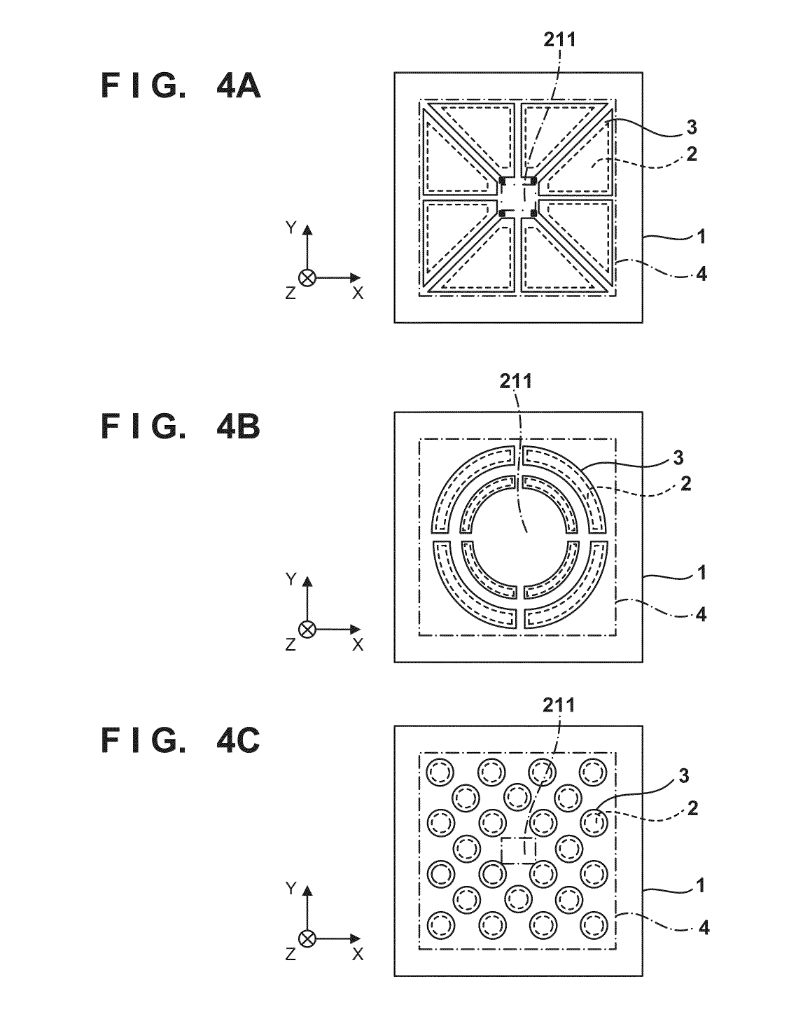

FIGS. 4A, 4B, and 4C show examples of the arrangement of the imprint head 30, respectively. FIGS. 4A, 4B, and 4C are views of the imprint head 30 when viewed from the substrate. In the example shown in FIG. 4A, the chucking surface of each holding unit 3 has a trapezoidal shape in which the width increases in a direction spaced apart from the pattern region 211. In the example shown in FIG. 4B, the chucking surface of each holding unit 3 has an arc shape. In the example shown in FIG. 4C, the chucking surface of each holding unit 3 has a circular shape. The shape of the chucking surface of each holding unit 3 and the array of the holding units 3 are not limited to these examples, and the holding units 3 can take various shapes and arrays. In addition to the holding units 3 which chuck the holding surface 222 of the original 4, the imprint head 30 may have a portion which supports or guides the holding surface 222.

Each of the driving units 2 can be configured to drive, along at least one of six axes, the holding unit 3 which should be driven by the driving unit 2. The six axes are three axes in the X, Y, and Z directions, and three axes along yawing, pitching, and rolling. The X and Y directions can be regarded as directions along the pattern region 211 of the original 4. The Z direction can be regarded as a direction perpendicular to the direction along the pattern region 211 of the original 4. Control of yawing, pitching, and rolling can be regarded as an operation to rotate the original 4. The driving units 2 can contract or expand the original 4. When the driving units 2 have a function of driving the original 4 in the Z direction, this function may be used to bring the resin and the pattern region 211 of the original 4 into contact with each other or release the pattern region 211 from the resin.

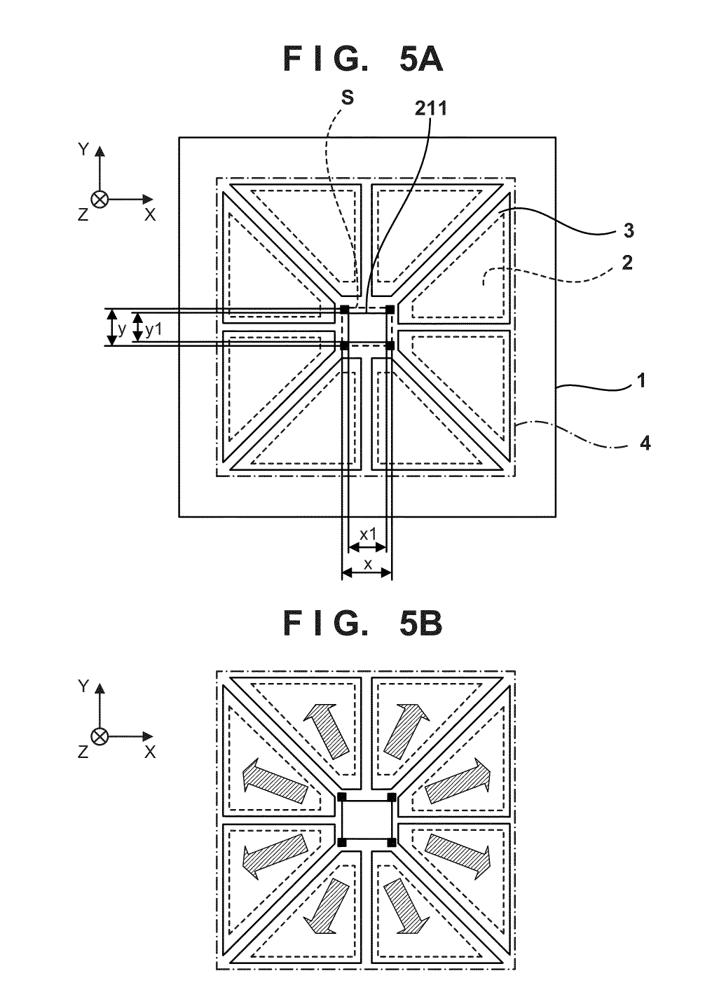

The first example of a method of aligning the original 4 with respect to the shot region of the substrate 5 will be explained with reference to FIGS. 5A and 5B. Correction of a pattern shape is strongly correlated to, for example, correction of the shape of the pattern region 211. By correcting the shape of the pattern region 211, the pattern shape can be corrected.

FIG. 5A schematically shows a state before the original 4 is aligned with respect to the shot region of the substrate 5. Shifts in shape and position between the pattern region 211 of the original 4 and the shot region of the substrate 5 are obtained by measuring, by the measurement device 7, the relative positions between a plurality of marks 9 formed on the original 4 and a plurality of marks 10 formed on the substrate 5. x and y are the X and Y sizes of a shot region S of the substrate 5, and x1 and y1 are the X and Y sizes of the pattern region 211 of the original 4. A difference δx between the X size x of the shot region S of the substrate 5 and the X size x1 of the pattern region 211 of the original 4 is x-x1. A difference δy between the Y size y of the shot region S of the substrate 5 and the Y size y1 of the pattern region 211 of the original 4 is y-y1. In this case, δx and δy can be decreased, that is, the original 4 can be aligned with respect to the shot region S by driving the holding units 3 by the driving units 2, as schematically indicated by arrows in FIG. 5B.

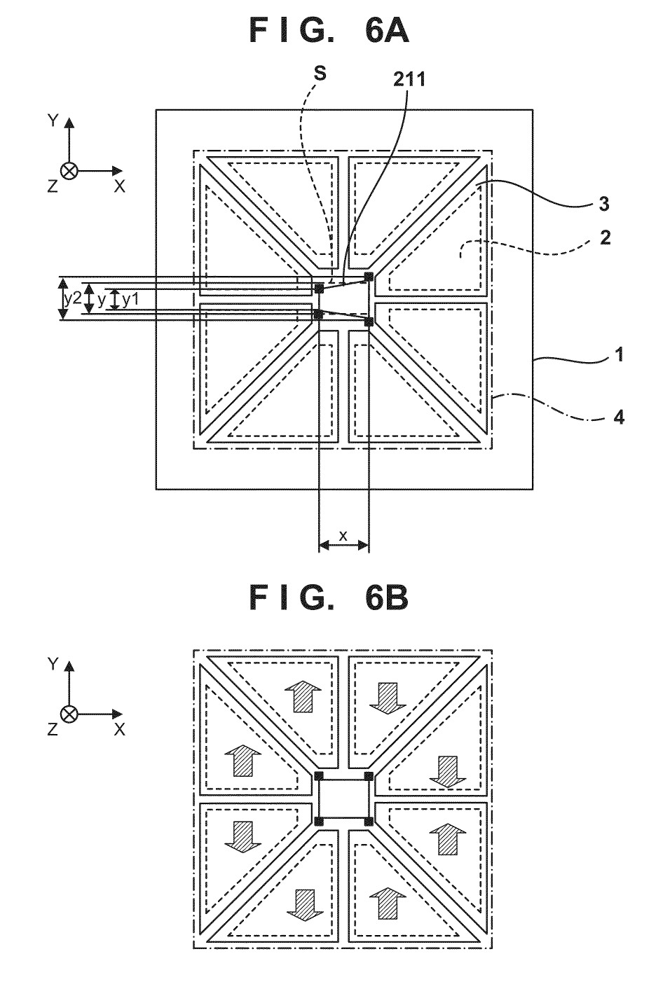

The second example of the method of aligning the original 4 with respect to the shot region of the substrate 5 will be explained with reference to FIGS. 6A and 6B. FIG. 6A schematically shows a state before the original 4 is aligned with respect to the shot region S of the substrate 5. x and y are the X and Y sizes of the shot region S of the substrate 5. x is also the X size of the pattern region 211 of the original 4, y1 is a Y size of the pattern region 211 of the original at one end, and y2 is a Y size of the pattern region 211 of the original at the other end. A difference δy1 between the Y sizes of the pattern region 211 and the shot region S of the substrate 5 at one end of the pattern region 211 of the original 4 is y-y1. A difference δy2 between the Y sizes of the pattern region 211 and the shot region S of the substrate 5 at the other end of the pattern region 211 of the original 4 is y-y2. In this case, δy1 and δy2 can be decreased, that is, the original 4 can be aligned with respect to the shot region S by driving the holding units 3 by the driving units 2, as schematically indicated by arrows in FIG. 6B.

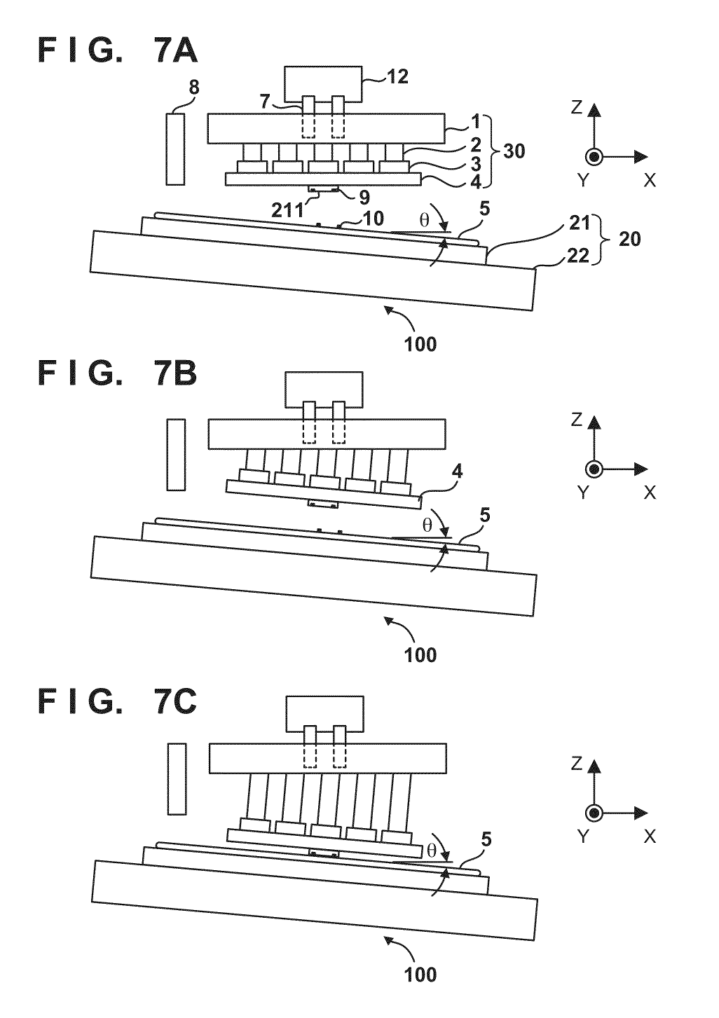

The third example of the method of aligning the original 4 with respect to the shot region of the substrate 5 will be explained with reference to FIGS. 7A to 7C. The distance (distance along the Z-axis) between the original 4 and each position of the shot region of the substrate 5 can be obtained by measurement using the measurement device 7.

FIG. 7A schematically shows a state before the original 4 is aligned with respect to the shot region S of the substrate 5. The pattern region of the original 4 is inclined by an inclination angle θ with respect to the shot region of the substrate 5. In this case, as schematically shown in FIG. 7B, the driving units 2 drive the holding units 3 to reduce the inclination angle θ. In this state, the elevating mechanism 1 can move down the original 4 to bring the pattern surface of the original 4 into contact with the resin on the shot region of the substrate 5, and the curing unit can cure the resin. Alternatively, when the driving units 2 are substituted for this function, the driving units 2 may move down the original 4 to bring the pattern surface of the original 4 into contact with the resin on the shot region of the substrate 5, as schematically shown in FIG. 7C.

The pattern region 211 may have a local inclination with respect to the shot region S of the substrate, that is, the surface shape of the shot region and that of the pattern region 211 may not coincide with each other. In this case, the driving units 2 can drive the holding units 3 so that the surface shape of the shot region and that of the pattern region 211 coincide with each other.

A method of manufacturing an article by using the above-described imprint apparatus will be explained. This manufacturing method includes a step of forming a resin pattern on a substrate by using the imprint apparatus, and a step of processing (for example, etching) the substrate on which the pattern is formed. The article can be a device such as a semiconductor device, liquid crystal display device, or micromachine.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-100348, filed Apr. 25, 2012, which is hereby incorporated by reference herein in its entirety.

What is claimed is:

1. A transfer apparatus which transfers a pattern of an original to a resin on a shot region of a substrate, the original including a first surface and second surface which are surfaces opposite to each other, the first surface including a pattern region where the pattern is formed, and the second surface including a holding surface, the transfer apparatus comprising:
a plurality of holding units configured to hold the holding surface of the original;
a plurality of driving units configured to drive the plurality of holding units, respectively; and
a control unit configured to control driving of the plurality of holding units by the plurality of driving units to align the pattern region with the shot region of the substrate.

2. The apparatus according to claim 1, wherein the plurality of driving units can drive the plurality of holding units in a direction along the pattern region.

3. The apparatus according to claim 1, wherein the plurality of driving units can drive the plurality of holding units in a direction perpendicular to a surface along the pattern region.

4. The apparatus according to claim 1, wherein the plurality of driving units can rotate the plurality of holding units.

5. The apparatus according to claim 1, further comprising a measurement device which measures positional shifts between a plurality of marks formed on the original and a plurality of marks formed on the substrate,
wherein the control unit controls driving of the plurality of holding units by the plurality of driving units to reduce the positional shifts.

6. The apparatus according to claim 1, wherein the second surface of the original includes a portion on a side opposite to the pattern region, and the holding surface is arranged to surround the portion.

7. The apparatus according to claim 1, wherein the transfer apparatus is configured to bring the pattern region of the original into contact with the resin on the substrate and cure the resin, thereby transferring the pattern to the resin.

8. The apparatus according to claim 7, wherein the plurality of driving units can drive the original to bring the pattern region of the original into contact with the resin on the substrate.

9. A method of manufacturing an article, comprising the steps of:
forming a pattern of a resin on a substrate by using a transfer apparatus; and
processing the substrate on which the pattern is formed,
wherein the transfer apparatus is configured to transfer a pattern of an original to a resin on a shot region of the substrate, the original including a first surface and second surface which are surfaces opposite to each other, the first surface including a pattern region where the pattern is formed, and the second surface including a holding surface, and
wherein the transfer apparatus comprises:
a plurality of holding units configured to hold the holding surface of the original;
a plurality of driving units configured to drive the plurality of holding units, respectively; and
a control unit configured to control driving of the plurality of holding units by the plurality of driving units to align the pattern region with the shot region of the substrate.
